(19) United States
(12) Patent Application Publication
(10) Pub. No.: US 2012/0060167 A1
(43) Pub. Date: Mar. 8, 2012

(54) METHOD AND SYSTEM OF SIMULATING A DATA CENTER

(76) Inventors: Michael A. Salsburg, Phoenixville, PA (US); Shivaram Venkat, Bangalore (IN); Mahesh Rudrachar, Bangalore (IN); MIIInd Halagerl, Bangalore (IN)

(21) Appl. No.: 12/877,191

(22) Filed: Sep. 8, 2010

(51) Int. Cl. G06F 9/06; G06F 9/46

(52) U.S. Cl. 718/104; 703/21

(57) ABSTRACT

A system and method for optimizing the dynamic behavior of a multi-tier data center is described, wherein the data center is simulated along with the resources in the form of hardware and software and the transaction process workloads are simulated to test the resources or the transaction process. The system requires the client computing device and a backend server to have the capabilities to host simulated hardware, complex software applications platforms, and to perform large scale simulations using these resources. The method includes securing parameter inputs from the client that defined the data center resources and the transaction process to be tested, generating various workload simulations, testing the simulations and provisioning the resources, thereby obtaining an optimized dynamic data center simulation of data center resources and the transaction processes.

### TECHNICAL FIELD

The present invention relates generally to a system and method of optimizing the dynamic behavior of a multi-tier data center by simulating the workload on the multi-tier data center using adaptable workload platforms to generate the workload and a variety of resources available to the data center.

### BACKGROUND

A data center simulator simulates the dynamic behavior of a data center by subjecting the data center resources to various loads in the form of process transactions that are simulated to resemble actual business transactions. The physical data center resources encompass a variety of devices like servers, computers and network components from which the throughput parameters are measured for the various loads.

Data centers generally form the core of any information technology (IT) operation. They are usually facilities with a number of high-end computers, network devices and power devices. The computers used in a data center range from gateway devices to common servers of different types including, without limitation, web application and database servers. Typical data center network components include routers, switches, bridge routers, Ethernet hubs, multiplexers, modems and repeaters. A few examples of power devices used within data centers include uninterrupted power supply (UPS) devices, redundant power supply devices, batteries, generators, power converters, stabilizers, coolers, detectors and alarm systems. Most online businesses have at least one backend data center that receives requests for data online and provides responses back to the query application.

Conventional methods for planning data center simulations provide various solutions including methods for individual server analysis in a multi layered data center network, methods for provisioning of hardware during overloading in the simulation, methods for traffic and transaction size analysis, methods for management studies and single workload generation model evaluation during simulation. Such schemes have significant drawbacks as they ignore the effect of a combination of server tiers, workload platforms and application software.

### SUMMARY

The systems and methods described herein attempt to overcome the drawbacks discussed above by dynamically optimizing the behavior of a multi-tier data center using a simulation application that combines server tiers, workload platforms and application software platforms, by generating output parameters and by provisioning resources in both hardware and software to obtain an optimized data center model.

Most data centers have a pool of resources in the form of physical hardware devices and several licensed software applications. Planning the requirements of new process transactions using the pool of data center resources is a difficult task. Such planning should consider the size of the transactions, the speed of responses, the power consumed and scalability among several other factors. Redundancy of data, security and reliability are other factors that are used in planning of the data center resources itself. A simulation removes uncertainty, saves time and money from the planning stages by providing estimates of the power consumed, health, processor time and memory used, among other performance metrics when certain process transactions are used on certain data center resources.

In one embodiment, a computer-implemented method of optimizing the dynamic behavior of a multi-tier data center by implementing a simulation application that is adaptable to a plurality of workload platforms and application system platforms comprises defining a plurality of resources available to the multi-tier data center as a first input parameter; defining a plurality of transaction processes to be processed by the multi-tier data center as a second input parameter; simulating, by a computer, the multi-tier data center model for each transaction process, thereby generating output parameters responsive to the two input parameters and a third input parameter defined by one of a plurality of workload platforms; analyzing, by a computer, the output parameters of the simulation to generate action items; provisioning, by a computer, the plurality of resources available to the multi-tier data center in response to the action items generated; and repeating the simulating, analyzing, and provisioning of the plurality of resources available to the multi-tier data center till an optimized dynamic behavior of the multi-tier data center is obtained.

In another embodiment, a computer-implemented method of testing transaction processes and multi-tier data center resources on an application resident on a client computing device, both the transaction processes and the multi-tier data center resources capable of being tested using a plurality of workload platforms and a plurality of application system platforms comprises defining the multi-tier data center resources and the transaction processes as input parameters on the application resident on the client computing device; sending, by a computer, the input parameters to a backend multi-tier data center simulation application; and receiving and displaying, by a computer, the results of the simulation application and its related input parameters for each of the transaction processes and the multi-tier data center resources, wherein the results are generated on the simulation application using the input parameters, the workload platform and any provisioned multi-tier data center resources, the results received and displayed in the application resident on the client computing device.

In yet another embodiment, a system for optimizing the dynamic behavior of a multi-tier data center by implementing a simulation application that uses a plurality of workload platforms and application system platforms comprises a client computing device capable of executing a software application for receiving input parameters responsive to resources of a multi-tier data center and at least one transaction process; the client computing device capable of sending the input parameters responsive to the resources of a multi-tier data center and the transaction process to a second computing device over a network; the second computing device capable of executing a simulation application using the input parameters and at least one of a plurality of workload platforms, the simulation application capable of generating optimized output parameters by provisioning the resources of the multi-tier data center using the workload platform and input parameters, thereby simulating an optimized multi-tier data center; and the second computing device capable of transmitting the output parameters of the optimized multi-tier data center back to the software application on the client computing device.

### BRIEF DESCRIPTION OF THE DRAWINGS

The accompanying drawings constitute a part of this specification and illustrate one or more embodiments of the disclosed system and methods, and further enhance the description thereof provided in this specification.

FIG. 1 illustrates a system architecture according to an exemplary embodiment.

FIG. 2 illustrates a method for dynamically optimizing the behavior of a multi-tier data center according to an exemplary embodiment.

FIG. 3 illustrates another method for dynamically optimizing the behavior of a multi-tier data center according to an exemplary embodiment.

### DETAILED DESCRIPTION

Reference will now be made in detail to exemplary embodiments of the disclosed data center simulation application, examples of which are illustrated in the accompanying drawings.

A discrete event simulation model is used to model the dynamic workload behavior of a data center. The primary components of this model are modules used to generate transaction processes, multi-tier data center resources, and a workload platform to generate the simulated workloads within a larger application. These components are written by software developers using computer instructions (commonly referred to as “code”) to create module applications. In some embodiments, the transaction processes are generated at a configuration builder component, which can comprise a library of XML files with parameters defined within it that are representative of an intended application. The data center resources for multiple tiers are defined in one or more separate XML files which may be stored in the same library. While XML files have been used as an exemplary method of forming the defining parameters for the transaction processes and the data center resources, JavaScript Object Notation (JSON) or other such markup languages or notations can also be used to develop input parameter files for the workload generator platform.

Provisioning of resources is a critical process in the data center simulation and the exemplary embodiments described below take into account a complex data center resource pool which includes the data center hardware resources, the transaction process requirements, and the software requirements for the transaction processes. In some embodiments, the software application platforms can be maintained separately from the hardware resource definitions and may contain metadata that tie the application platform to hardware requirements. These software application platforms are referred to herein as “personas”. Some embodiments use an XML file comprising a reference correlation between the software application platform and the hardware resources. In such embodiments such a correlation can be created and stored in the configuration builder library. Such an implementation can allow for a larger pool of resources and reduced software licensing costs. Some embodiments may combine a plurality of data center resources in the form of multi-tiered servers including web or virtual servers, application servers and database servers that are consolidated to a single physical server during the simulation. Such consolidation allows the server to be moved around from the tiers into a common pool and so can the application platforms within the servers. Such a level of combination and personalization affords a highly accurate data center model.

In one embodiment, the data center simulation application is resident on a client computing device and is networked to a second computing device; the second computing device could be a backend server that processes the input from the application on the client computing device and provides the results to the data center simulation application. This helps obviate issues related to processing time for complex multi-tier data center models and allows the data center simulation application to be used in simple network-enabled client computing devices. Such devices may include, without limitation, personal computers, netbooks, Smartphones (e.g., the cellular telephones employing operating systems distributed by Apple, BlackBerry, Palm and Google), laptops and mobile phones. The input parameters are defined by the requirements of the transaction process being tested on the data center simulation application. Some exemplary transaction process input parameters include, without limitation, number of arrivals, mean arrival rate, web mean service time for CPU, web mean service time for input and output, database mean service time for CPU, database mean service time for input and output, and network latency. Arrivals, as used in the example given above, relate to the number of transaction requests that the server receives in a certain period. The service time is the time to throughput on an input request. If the request requires the application server in one tier to seek data from the database server in another tier and then transform the data using a math function, the service time for the request is likely to be high when compared against a search request that simply requires the application server to secure requested data from the database server and return the result to the web server for the client application.

A further exemplary embodiment requires the client to define the data center resource pool, e.g., the number of servers, the application platforms, and the network devices required to implement the transaction processes being examined by the simulation. This allows the simulator to define different network architectures, e.g., Infiniband Architecture (IBA), TCP/IP, Open system interconnection (OSI), Gigabit Ethernet, and the like. Additional embodiments use the results from a first simulation to automatically reallocate resources thereby provisioning the software, hardware and personas to secure faster service times, improve power savings, reduce resource consumption, and the like. In another embodiment, when a queue is generated in the form of transaction process requests by the workload generator, the generator attempts to implement a M/M/1 server queue, which is a Kendall's notation indicating a Markovian distribution for interarrival service time and service time distribution on a single server with Poisson arrivals and unlimited capacity. Each server in each tier of the data center resources is an M/M/1 server in one exemplary embodiment. This also allows the data center simulation application to test multiple queue methods other than M/M/1 on its servers to generate the best result.

Another exemplary embodiment provides the client with a number of workload generator platforms to generate different types of workload associated with the input parameters from the client. The combination of the data center resources parameter and the transaction process parameters can be used in a broad C Simulator (CSIM) platform to generate user defined workload output or in a more narrow Rice University Bidding System (RUBiS) platform that tests certain application programming interface (API) objects. Such objects may include, without limitation, the Java data objects (JDO) studying the servlets within the application, session beans (component of an enterprise applications) and Java database connectivity (on the database tier). The RUBiS platform tests emulate an online bidding system with focus on application design and scalability. Since each workload generator functions differently and also works differently with different application platforms (dependent on the transaction processes being tested), it can be advantageous for a simulator to be able to apply varying workload generation platforms to augment the input parameters. Further, workload platforms like Webjamma and RUBiS are closed system models as the request load (queue) at the server is completely dependent on the departures (or output) from the server. Other workload generator platforms like Sclient and SPEC are considered open system models, where the request load at the server is independent of the completed work. There is no maximum number of users on the open system while there needs to be a fixed number on the closed system.

The simulation application takes the output parameters from the workload generator platform in the form of values for CPU usage, memory usage and other metrics and determines the need to optimize to a single or multiple metrics. This means that the simulator provisions the data center resources by securing the current resources and reallocating them as applicable to the personas used by the transaction processes. The simulation application can use a sub-application to determine which resources can be moved from the tiers and update the personas via the XML correlation file. By way of example, without limitation, a database intensive transaction process can reallocate hardware and software resources via the personas to add a database server to the database tier pool. The result is a more optimized model which is sent to the client device running the user interface to the multi-tier data center simulation application.

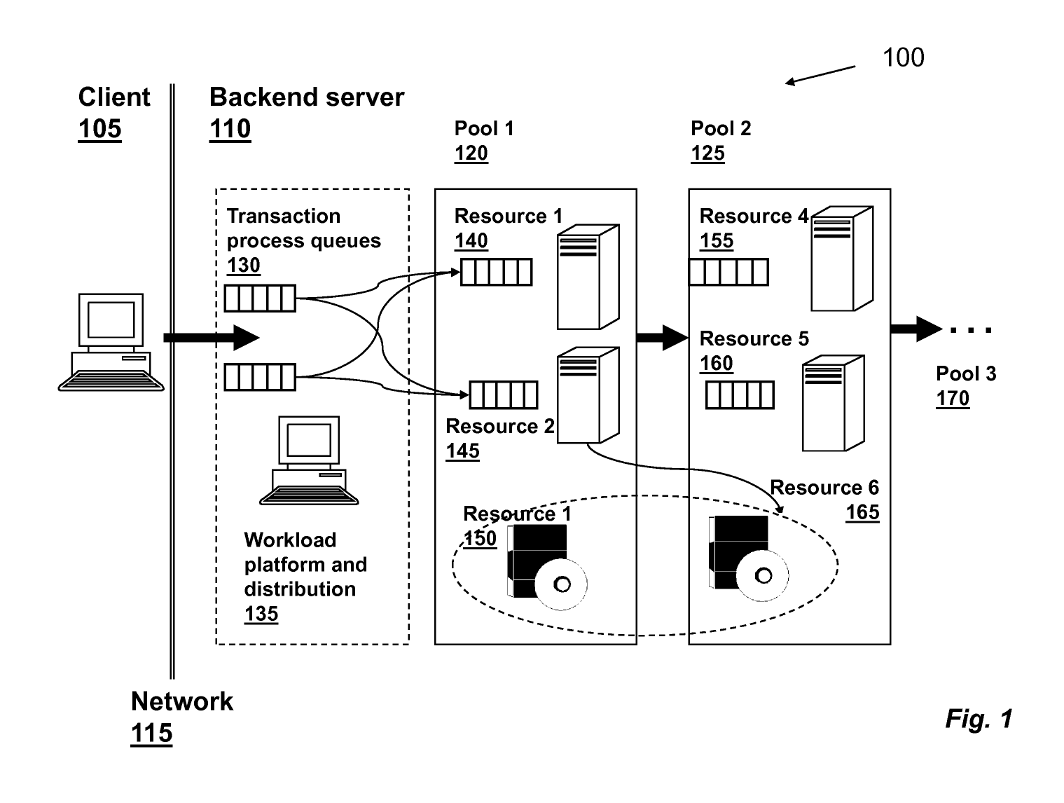

FIG. 1 illustrates an exemplary architecture which can support a multi-tier data center simulation system 100. In the illustrated embodiment a network interface device allows a client computing device 105 to communicate through a network 115, e.g., a local area network (“LAN”), wide area network (“WAN”) such as the internet, or the like, with backend servers 110. The client computing device 105 can be any network-enabled computing device, e.g., a personal computer, laptop, tablet computer, netbook, mobile phone, Smartphone, personal data assistant, or other such device with at least one storage unit, at least one processor for executing instructions read from the storage unit, and wireless and/or wired networking capability.

In the illustrated embodiment, the client computing device 105 comprises a client software application, which, when read from the storage unit and executed by the processor, interacts with backend components, provided by backend servers 110, to form the multi-tier simulation application. The client application provides a user interface (e.g., comprised of fields, drop-down lists, buttons, and other such user interface elements) that can allow a user to configure inputs to a simulator which can be used to simulate the data center and to test the data center on various test applications. Exemplary inputs to the simulation application include the data center resources in the form of hardware and software, and the transaction processes to be tested. The transaction process could model a wide range of applications. In some embodiments, the transaction process could be a full-fledged software application that interacts with a front-end user and secures data from a back-end database server while performing various functions on the data and providing the results to the front-end user, e.g., a complete online banking application or a cloud computing system. In some embodiments, the transaction process could be a single transaction within an larger software application, e.g., a mobile banking application that processes single requests like balance transfers or bill pay. Once the user has defined input parameters on the client software, the parameters are sent to a first one of backend servers 110 for workload generation and distribution 135. In the exemplary embodiment illustrated in FIG. 1, the backend servers 110 comprise a wise range of computing devices such as, without limitation, those used in the data center simulation application or parts of the application. In other embodiments, backend servers 110 could also be a single server with the capacity to perform simulations of large complex data center models. These models emulate thousands of transaction processes, hardware and software resources as well as different types of queues.

As discussed above, some exemplary input parameters include number of arrivals, mean arrival rate, web mean service time for CPU, web mean service time for input and output, database mean service time for CPU, database mean service time for input and output and network latency. These parameters define the expected use of the transaction process and the intended hardware that will be applied to a real-time data center. The workload platform generates transaction processes based on the input parameters and defines a queue 130 depending on the type of the transaction processes. Different types of workload platforms are available on this backend server for closed or open system models and for testing different types of applications. Playback for HTTP streams use Webjamma or Siege for workload generation and benchmarking while mail servers rely on tools developed by Standard Performance Evaluation Corp., like the SPECmail2001 platform. It should be appreciated that based on the type of transaction process being tested, the workload platform can automatically choose the right platform for testing the transaction process.

In the illustrated embodiment, the queues are sent to simulated backend pools 120 of data center resources 140 to 165. The resources illustrated in the exemplary system of FIG. 1 comprise hardware (140, 145, 155, 160) and software resources (150, 165) and are virtual resources available within the simulation model. These resources are set forth in the figure to indicate the structure in the physical data center. The hardware resources are often split further into processors and data storage units that can be shared within the pool or between pools. For example, resource 2 145 can be shared from pool 1 120 to pool 2 125 in its entirety or as parts (e.g., processor capacity alone). Maintaining that the devices shown as resources 1, 2, 4, and 5 are virtual and not physical for the purpose of the simulation application, the sharing of resources are detailed via output parameters once an optimized simulated data center model has been achieved. Further, according to exemplary embodiment, the pools 120, 125, and 170 are multi-tiers and each pool serves a particular purpose, e.g., web server, application servers and database servers.

The requirements of the servers in the pools are different based on their functions and therefore, sharing of resources is related to the requirement of the transaction processes. In certain cases, the transaction process is more data dependent and the database server resources are in higher demand compared to the application server pool. If the database servers require additional processing capability, the application server resources can be used to satisfy the processer requirements of the high demand pools. This process is easier in the virtual simulation of the data center but complex in a physical data center, it is therefore beneficial to test these parameters prior to implementing them. Similarly, software application platforms are expensive to license on multiple devices, these can instead be shared if it is established during the simulation that a single software application platform can perform additional tasks required by the transaction processes. These software application platforms, also called personas, are tied to the resources via metadata or XML files in the input parameters that tell the simulator that certain applications require certain processing and temporary memory (e.g., random access memory (RAM)) capacities to function.

The simulator simulates the multi-tier data center using the resources and the transaction processes defined by the input parameters and can determine whether the system is optimized to the requirements of the end-user. Should the simulated data center need further optimization, whether defined automatically or by the user, to work with minimum latency, minimum resources or other such requirements, the simulator can automatically provision the resources in the pools 120, 125, 170 to reflect such changes. The simulator will then run again and provide output parameters to the end-user interface on client 105.

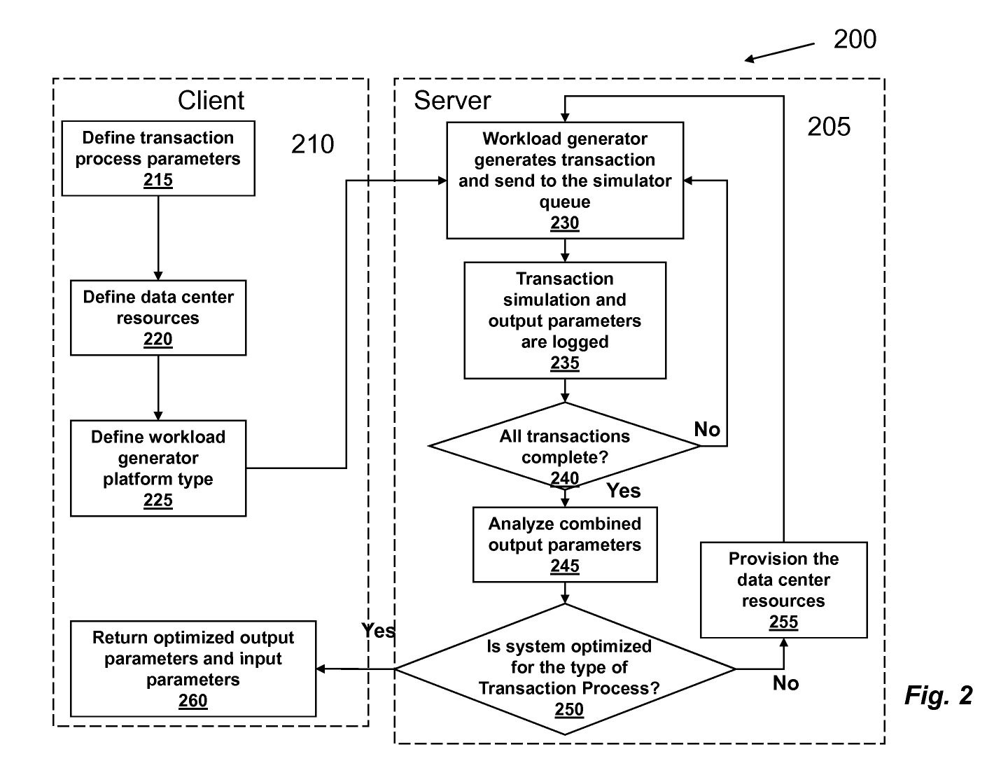

In one example, a client application is deployed on the client 210 as illustrated in the exemplary embodiment in FIG. 2. The client application is used to define input parameters in the form of transaction process parameters 215, the data center resources 220 and the workload generator platform 225. Another embodiment would allow the simulator on the backend server 205 to automatically decide the type of workload generator platform that the transaction process will be tested with. A further embodiment would allow the simulator to try multiple platforms to optimize the data center resources to the transaction processes being tested.

The exemplary embodiment of FIG. 2 further illustrates the server side 205 of the simulator application which accepts the input parameters from the client 210 and uses the chosen workload platform to create the workload queues 230 that will be used to simulate the load on the data center resources. The simulation is started for a first run and the output parameters logged 235. The simulator then verifies if the queues are empty 240, indicating that all transaction processes have been exhausted. If this is the case, then the simulator analyzes the combined results 245 of the output parameters to compare 250 against the intended parameters defined by the client or the intended parameters as is pre-defined within the simulator. If the intended parameters are not met, the data center resources are provisioned 255 in a different manner than in the first run and the workload generator is fed with the re-allocated resources that are compiled by the system to generate a new set of output parameters for verification. The final optimized data center model is sent 260 to the client 210 with the input parameters that generated the optimized model. It should be appreciated that the simulator can be used to generate multiple models using different combinations of data center resources 220 and workload generator platform types 225 which can then be compared for optimized efficiency.

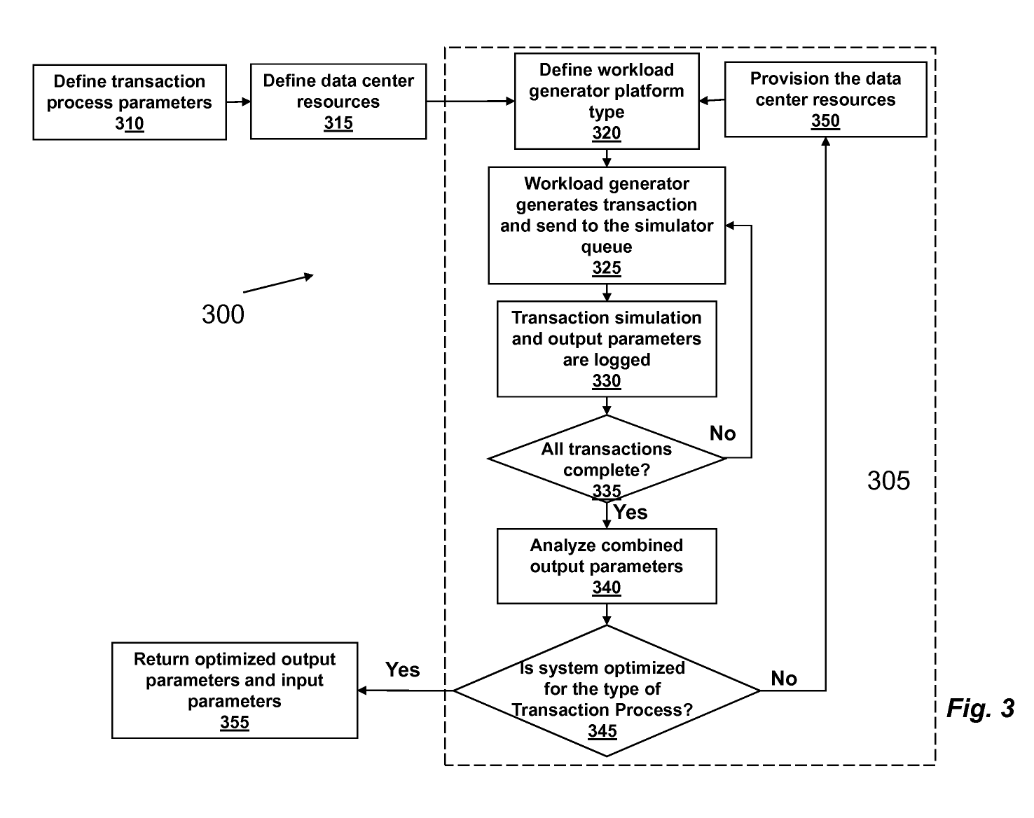

In another exemplary embodiment, a multi-tier data center simulator 300 is illustrated in FIG. 3, where 305 is the core of the simulator. The input parameters 310, 315 of the transaction process to be tested are defined by the client in the form of XML files on a dot NET (.NET) API platform. The workload generator platform 320 is defined by the transaction processes based on the type of applications software platforms required by the process. CSIM is an application that can be used to generated workload and compare the output and input parameters. The CSIM application can accept inputs in the form API responses on a dot NET (.NET) platform where the inputs were defined in XML files. The workload generator simulates the load and applies it as queues 325 to the simulator application which generates the output parameters 330. The parameters are combined when all the transactions are completed 335 and analyzed 340 to determine if the multi-tier data center simulator 305 is optimized for the transaction processes. If this is not the case, the data center resources are provisioned 350 are provisioned and a new workload generator platform is defined 320 and the simulation is restarted. The final simulation can be checked against any prior simulation or the intended optimized parameters. Once the system is optimized, the output parameters and the input parameters (along with the provisioned resources) are provided as output results to the client 355. Output parameters can include the processor utilization, memory utilization, resource utilization and response time among other parameters.

The embodiments described above are intended to be exemplary. One skilled in the art recognizes that numerous alternative components and embodiments that may be substituted for the particular examples described herein and still fall within the scope of the invention.

What is claimed is:

1. A computer-implemented method of optimizing the dynamic behavior of a multi-tier data center by implementing a simulation application for at least one of a plurality of workload platforms and application system platforms, the method comprising:
defining a plurality of resources available to the multi-tier data center as a first input parameter;
defining a plurality of transaction processes to be processed by the multi-tier data center as a second input parameter;
simulating, by a computer, the multi-tier data center model for each transaction process, thereby generating output parameters responsive to the two input parameters and a third input parameter defined by one of a plurality of workload platforms;
analyzing, by a computer, the output parameters of the simulation to generate action items;
provisioning, by a computer, the plurality of resources available to the multi-tier data center in response to the action items generated; and
repeating the simulating, analyzing, and provisioning of the plurality of resources available to the multi-tier data center until an optimized dynamic behavior of the multi-tier data center is obtained.

2. The method according to claim 1, wherein the workload platform is a closed model platform.

3. The method according to claim 1, wherein the workload platform is an open model platform.

4. The method according to claim 1, wherein the resources available to the multi-tier data center and the plurality of transaction processes are defined in Extended Markup Language (XML) files.

5. The method according to claim 1, wherein the resources available to the multi-tier data center and the plurality of transaction processes are sent to the simulation application in the form of a library of Extended Markup Language (XML) files.

6. The method according to claim 3, wherein the library of Extended Markup Language (XML) files is established as a library in a dot NET (.NET) framework made available to the simulation application in the form of Application Programming Interface (API) inputs.

7. The method according to claim 1, wherein the plurality of resources available to the multi-tier data center is selected from at least one of a server, a computer, a router, a switch, a hub, a network card, and a modem.

8. The method according to claim 5, wherein the plurality of resources available to the multi-tier data center includes a plurality of application system platforms.

9. The method according to claim 1, wherein the transaction processes includes stand-alone software applications or shared software applications.

10. The method according to claim 1, wherein the plurality of resources available to the multi-tier data center is a logical grouping of computing devices along with the operating systems and applications resident on the computing devices.

11. The method according to claim 1, wherein the simulation application sends to a third party software the output parameters from the simulation and receives from the third party software application the analysis in the form of action items.

12. The method according to claim 1, wherein the simulation application sends to a third party software the action items from the simulation application and receives from the third party software the provisioning instructions for the plurality of resources available to the multi-tier data center.

13. The method according to claim 1, wherein the plurality of resources available to the multi-tier data center includes virtual machines and cloud computing resources.

14. The method according to claim 1, wherein the tiers in the multi-tier data center includes an application server, a web server, and a database server.

15. The method according to claim 1, wherein the output parameters comprise at least one of processor (CPU) utilization, memory utilization, energy utilization, heat generated for the multi-tier data center resources, and response time for each transaction process.

16. The method according to claim 1, wherein the plurality of transaction processes is defined by using configurable parameters for the transaction process comprising at least one of number of transaction process arrivals, mean service time by the processor (CPU), mean inter arrival time, network latency, amount of memory used, number of multi-tier data center resources available and mean throughput service time.

17. The method according to claim 1, wherein new multi-tier data center resources are defined as an additional input parameter to the simulation application.

18. The method according to claim 1, wherein the provisioning the plurality of resources available to the multi-tier data center is automated to respond to pre-defined intended output parameters.

19. A computer-implemented method of testing transaction processes and multi-tier data center resources on an application resident on a client computing device, both the transaction processes and the multi-tier data center resources capable of being tested using a plurality of workload platforms and a plurality of application system platforms, the method comprising:
defining the multi-tier data center resources and the transaction processes as input parameters on the application resident on the client computing device;
sending, by a computer, the input parameters to a backend multi-tier data center simulation application; and
receiving and displaying, by a computer, the results of the simulation application and its related input parameters for each of the transaction processes and the multi-tier data center resources, wherein the results are generated on the simulation application using the input parameters, the workload platform and any provisioned multi-tier data center resources, the results received and displayed in the application resident on the client computing device.

20. The method according to claim 18, wherein the workload platforms used to generate the workload is be selected on the application resident on the client computing device.

21. The method according to claim 18, wherein the application resident on the client computing device is a web application on a browser window.

22. The method according to claim 18, wherein the application resident on the client computing device is a stand-alone application.

23. The method according to claim 18, wherein the plurality of transaction processes as an input parameter is available as Application Programming Interface (API) inputs to the application resident on the client computing device from a library in a dot NET (.NET) framework of Extended Markup Language (XML) files.

24. The method according to claim 18, wherein the plurality of multi-tier data center resources as an input parameter is available to the application resident on the client computing device and is selected from at least one of a server, a computer, a router, a switch, a hub, a network card, and a modem.

25. The method according to claim 18, wherein new multi-tier data center resources are defined as an additional input parameter on the application resident on the client computing device.

26. The method according to claim 18, wherein the client computing device and the multi-tier data center resources comprise more than one application system platform.

27. A system for optimizing the dynamic behavior of a multi-tier data center by implementing a simulation application that uses a plurality of workload platforms and application system platforms, the system comprising:
a client computing device capable of executing a software application for receiving input parameters responsive to resources of a multi-tier data center and at least one transaction process;
the client computing device capable of sending the input parameters responsive to the resources of a multi-tier data center and the transaction process to a second computing device over a network;
the second computing device capable of executing a simulation application using the input parameters and at least one of a plurality of workload platforms, the simulation application capable of generating optimized output parameters by provisioning the resources of the multi-tier data center using the workload platform and input parameters, thereby simulating an optimized multi-tier data center; and
the second computing device capable of transmitting the output parameters of the optimized multi-tier data center back to the software application on the client computing device.

28. The system according to claim 27, wherein the plurality of resources available to the multi-tier data center is selected from at least one of a server, a computer, a router, a switch, a hub, a network card, and a modem.

29. The system according to claim 27, wherein provisioning the resources of the multi-tier data center further comprises combining and reallocating the software from the application system platforms and the hardware from the resources of the multi-tier data center.

30. The system according to claim 27, wherein provisioning the resources of the multi-tier data center is automated to respond to the a pre-defined set intended output parameters.

31. The system according to claim 27, wherein the client and second computing devices are capable of handling a dot NET (.NET) framework of Extended Markup Language (XML) files with Application Programming Interface (API) outputs and inputs between the devices.

32. The system according to claim 27, wherein the tiers in the multi-tier data center includes an application server, a web server and a database server.
